(19) United States
(12) Patent Application Publication
(10) Pub. No.: US 2025/0052633 A1
(43) Pub. Date: Feb. 13, 2025

(54) PRESSURE TRANSDUCER AND DIFFERENTIAL PRESSURE TRANSDUCER

(71) Applicant: Endress+Hauser SE+Co. KG, Maulburg (DE)

(72) Inventors: Raimund Becher, Ehrenkirchen (DE); Kristine Bedner, Schopfheim (DE); Tobias Anders, Rheinfelden (DE)

(21) Appl. No.: 18/718,577

(22) PCT Filed: Nov. 21, 2022
(86) PCT No.: PCT/EP2022/082663

§ 371 Date: Jun. 11, 2024

(30) Foreign Application Priority Data
Dec. 15, 2021 (DE) 10 2021 133 184.6

(51) Int. Cl. G01L 19/06; G01L 13/06; G01L 19/14

(52) U.S. Cl. CPC G01L 19/0627; G01L 13/06; G01L 19/143

(57) ABSTRACT

A pressure transducer comprises a process module having a cylindrical main part made of a first material, wherein a pressure-sensitive process diaphragm and an axially disposed through-hole are provided in the main part, and a measuring module having a cylindrical base which is manufactured from a second material that differs from the first material. The base has a pressure sensor and a pin-like-portion, wherein the pin-like portion-projects into the through-hole such that an end portion of the pin-like portion is flush with the end portion of the main part facing the medium. The end portion of the pin-like portion is connected to the end portion of the main part facing the medium, wherein the pin-like portion tapers in the direction of the end portion of the pin-like portion.

The invention relates to a pressure transducer for determining a first pressure of a medium and a differential pressure transducer for determining a differential pressure from a first pressure and a second pressure.

In pressure measurement technology, absolute, differential and relative pressure transducers are known. Absolute pressure transducers determine the prevailing pressure of a medium absolutely, i.e., in relation to vacuum, while differential transducers determine the difference between two different pressures of the medium or media. In the case of relative pressure transducer, the pressure of the medium to be measured is determined relative to a reference pressure, wherein the atmospheric pressure prevailing in the environment of the relative pressure transducer serves as reference pressure. In the following, relative and absolute pressure transducers are referred to as pressure transducers to distinguish them from differential pressure transducers.

Both pressure transducers and differential pressure transducers have a pressure-sensitive measuring element, the so-called pressure sensor, to the first and second surfaces of which a pressure is applied. In the case of pressure transducers, the pressure of the medium to be determined acts on the first surface of the pressure sensor, while an absolute or reference pressure acts on the second surface. In the case of differential pressure transducers, the pressure of a medium is applied to both surfaces. The measuring element bends as a function of the relative pressure present, which is formed from the difference between the pressures applied to the two surfaces. This bending is converted by means of an electronic unit into an electrical signal, which depends on the relative pressure and is then available for further processing or evaluation. In this case, a distinction is made, inter alia, between capacitive and piezo-resistive pressure sensors. The companies of the Endress+Hauser Group manufacture and market a variety of such relative pressure transducers.

Pressure and differential pressure transducers can be exposed to a variety of different media, such as acids and alkalis, which can put a lot of strain on the material of the pressure and differential pressure transducers. The environment of the pressure and differential pressure transducers can also pose a challenge for the material if the measuring point is located near seawater, for example. Acids, alkalis, seawater and other corrosive media corrode the regions of the pressure and differential pressure transducers that are in contact with the corrosive media, and thereby shorten the service life of the respective transducer.

Stainless steel only has limited corrosion resistance and is therefore not suitable for contact with corrosive media. If stainless steel contains more than 10.5% chromium, which must be dissolved in the austenitic or ferritic solid solution of the steel, the steel is considered stainless. The corrosion resistance of stainless steel can be further improved by adding other alloy components such as nickel or molybdenum, although this also significantly increases the price of the stainless steel. The corrosion resistance of a stainless steel can be classified using the PREN index. PREN stands for pitting resistance equivalent number, which indicates the resistance of a steel to pitting and crevice corrosion. Steels with a PREN number of over 32, for example, are resistant to seawater, which corresponds to a very high level of corrosive stress.

For processes with corrosive media, it is therefore desirable for the pressure and differential pressure transducers to be made of a material that is as corrosion-resistant as possible. The disadvantage, however, is that the manufacturing costs are significantly higher when using such a material than when using stainless steel. In principle, it is possible to manufacture the pressure or differential pressure transducer only partly from an expensive, corrosion-resistant material and partly from an inexpensive stainless steel. However, when the two materials are joined, for example by welding, a hysteresis effect occurs in the pressure sensor due to the different coefficients of thermal expansion of the corrosion-resistant material and the stainless steel. If the temperature around the pressure or differential pressure transducer fluctuates greatly, the weld between the two materials may even crack.

The object of the present invention is therefore to provide a pressure transducer and a differential pressure transducer which are characterized by high corrosion resistance and can be produced at low cost.

This object is achieved according to the invention by a pressure transducer according to claim 1 and a method according to claim 15.

With regard to the pressure transducer for determining a first pressure of a medium, the object is achieved by a pressure transducer comprising:
a process module with a cylindrical main part made of a first material,
   wherein a pressure-sensitive process diaphragm is provided in an end portion of the main part facing the medium,
   wherein the main part has an axially disposed through-hole which tapers towards the end portion of the main part facing the medium.
a measuring module having a cylindrical base, the process module and the measuring module being axially aligned with each other and connected to each other in a respective connection region of a respective end face of the process module and the measuring module, the base being made of a second material which is different from the first material, the base having a pressure sensor and a pin-like portion,
   wherein the pin-like portion projects into the through-hole in such a way that an end portion of the pin-like portion is flush with the end portion of the main part facing the medium, wherein the end portion of the pin-like portion is connected to the end portion of the main part facing the medium, wherein the pin-like portion tapers in the direction of the end portion of the pin-like portion, wherein the pin-like portion has a capillary which is designed to transmit the first pressure of the medium from the process diaphragm to a first surface of the pressure sensor,
   wherein the pressure sensor is subjected to a second pressure on a second surface opposite the first surface.

According to the invention, the pressure transducer is made up of two modules, the process module facing the process and the medium being made of a different material than the measuring module facing away from the process and the medium. In this way, it is possible to manufacture the process module from a more expensive material, for example, and the measuring module from a less expensive one, thus obtaining an economical pressure transducer.

As described at the beginning, the use of different materials in the pressure transducer generally leads to temperature and hysteresis effects. According to the invention, these problems are avoided by means of the tapering of the pin-like portion and the main part.

The pin-like portion represents a pin-like lengthening or an extension of the measuring module. The pin-like portion has a taper in the direction of the end portion of the pin-like portion, wherein this taper can be a continuous or a step-like or sectional taper. In any case, at least a first diameter of the pin-like portion in a region adjacent to the end portion of the pin-like portion is larger than a second diameter in the end portion of the pin-like portion. Similarly, the taper of the through-hole can also be a continuous or a step-like or sectional taper. Here too, a first diameter of the through-hole in a region adjacent to the end portion of the main part is always larger than a second diameter of the through-hole in the end portion of the main part.

By the pin-like portion being tapered in its end portion and the through-hole being tapered, temperature-related or temperature-dependent distortion forces and/or stresses in the region of the connection between the end portion of the pin-like portion and the end portion of the main part are deflected away from the connection when the end portion of the pin-like portion is connected to the end portion of the main part, so that the connection is mechanically decoupled. In particular, the taper of the pin-like portion and/or the taper of the through-hole is designed in such a way that at least a, in particular temperature-dependent, stress and/or distortion force is dissipated from the connection between the end portion of the pin-like portion and the end portion of the main part.

The capillary is, in particular, a pressure transmission line which is filled with a pressure transmission fluid. The process diaphragm is subjected to the first pressure of the medium. The pressure sensor is disposed in a recess in the base, for example.

Preferably, the first material is a corrosion-resistant material. The main part of the process module is therefore designed to be corrosion-resistant and can also be used with corrosive media without the process module being thereby impaired or damaged. For example, the first material has a PREN number of over 32.

Advantageously, the second material is less corrosion-resistant than the first material. In this case, the main part of the process module is designed to be more corrosion-resistant than the base of the measuring module. This means that only the main part can be made from a more expensive material, and a less expensive material can be selected for the base, which significantly reduces the manufacturing costs of the pressure transducer compared to a conventional pressure transducer made entirely from a corrosion-resistant material.

In one embodiment, the first material is a nickel alloy. Nickel alloys generally have high corrosion resistance and are therefore also suitable for use in corrosive media.

In a further embodiment, the first material is Hastelloy, Inconel or Monel. Hastelloy and Inconel are nickel-based alloys, Monel is a nickel-copper alloy. All three materials are characterized by very high corrosion resistance.

In a further embodiment, the second material is a steel. Since the measuring module has no contact with the medium, an inexpensive steel can be selected for the base.

In a further development, the respective connection region of the end face of the process module and the end face of the measuring module is ring-shaped.

In one embodiment, the connection region of the process module and/or the connection region of the measuring module is designed as a step, shoulder, projection or edge, the connection region of the process module and the connection region of the measuring module being designed to correspond to each other.

Preferably, the process module and the measuring module only touch in the respective connection region and between the end portion of the pin-like portion and the end portion of the main part facing the medium. In order to reduce the influence of temperature-dependent stresses and/or distortion forces, contacts between the measuring module and the process module are only provided in two regions in this embodiment.

In one embodiment, the process module and the measuring module are connected in the respective connection region of the respective end face by means of a first weld, the end portion of the pin-like portion being connected to the end portion of the main part facing the medium by means of a second weld.

Advantageously, a pin is disposed inside the capillary, which is designed in such a way that the pin, together with the capillary, acts as a flashback arrestor. An explosion occurring in one end portion of the pin is stopped by the pin in conjunction with the capillary and cannot spread beyond the pin. In particular, there are only narrow gaps between a wall of the capillary and an outer wall of the pin. This has the additional effect of reducing the volume of pressure transmission fluid in the capillary, which can only be present in the gaps.

In a further development, the main part of the process module has an attachment region for a connection to a process connection.

In one embodiment, the pressure sensor is separated from at least one electronic unit by means of an electrically insulating feed-through element, which is inserted into a recess in the base. The feed-through element is used to feed through electrical cables that run between the at least one electronic unit and the pressure sensor. In particular, the feed-through element is made of the same material as the base in order to achieve an identical coefficient of thermal expansion. Otherwise, if the feed-through element is welded to the base, temperature-related stresses and/or distortion forces occur in the region of the weld, which can have a negative impact on the pressure sensor, for example, in the form of hysteresis effects.

In a further embodiment, the second pressure is an absolute pressure or a reference pressure, wherein in the case of the reference pressure, the base has a reference air bore which is designed to guide the reference pressure through the base to the second surface of the pressure sensor.

With regard to the differential pressure transducer for determining a differential pressure from a first pressure and a second pressure, the object is achieved by a differential pressure transducer comprising:
two process modules, each with a cylindrical main part made of a first material,
   wherein a pressure-sensitive process diaphragm is provided in each end portion of the main part facing the medium, the first process diaphragm being subjected to the first pressure and the second process diaphragm being subjected to the second pressure.
   wherein the main part has an axially disposed through-hole which tapers towards the end portion of the main part facing the medium.
a measuring module with a cylindrical base, the two process modules each being aligned axially to the measuring module and connected to one another in a respective connecting region of a respective end face of the respective process module and a respective end face of the measuring module, the base being made of a second material which differs from the first material, the base having a pressure sensor and two pin-like portions,
   wherein the two pin-like portions each project into the through-hole of the respective main part in such a way that in each case one end portion of the pin-like portion is flush with the respective end portion of the main part facing the medium, the respective end portion of the pin-like portion being connected to the respective end portion of the main part facing the medium, the two pin-like portions tapering in the direction of their respective end portion, the two pin-like portions having a first capillary and a second capillary, the first capillary being designed to transmit the first pressure from the first process diaphragm to a first surface of the pressure sensor, and the second capillary being designed to transmit the second pressure from the second process diaphragm to a second surface of the pressure sensor opposite the first surface.

The embodiments of the pressure transducer according to the invention also apply analogously to the differential pressure transducer according to the invention.

The differential pressure transducer according to the invention determines a differential pressure from a first pressure and a second pressure so that two process diaphragms, the first and the second process diaphragm, and consequently two process modules are required. The measuring module is connected to both process modules and can be designed in one or more parts.

In a manner analogous to the pressure transducer according to the invention, the differential pressure transducer according to the invention is also achieved by using different materials for the main part of the process modules and the base of the measuring module which are, for example, different in price, so that the differential pressure transducer can be manufactured inexpensively. Temperature-dependent stresses and/or distortion forces which can arise from the connection of the two different materials, are avoided by the tapering of the pin-like portion in conjunction with the tapering of the through-hole.

The pin-like portions represent a pin-like lengthening or an extension of the measuring module. The taper of the pin-like portion and/or the taper of the through-hole can be a continuous, or a step-like, or sectional taper. At least a first diameter of the pin-like portion in a region adjacent to the end portion of the pin-like portion is larger than a second diameter in the end portion of the pin-like portion. A first diameter of the through-hole in a region adjacent to the end portion of the main part is also larger than a second diameter of the through-hole in the end portion of the main part.

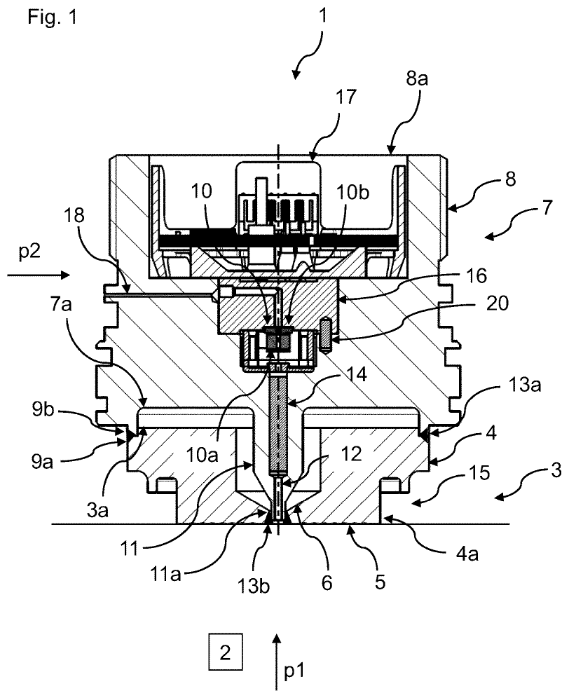

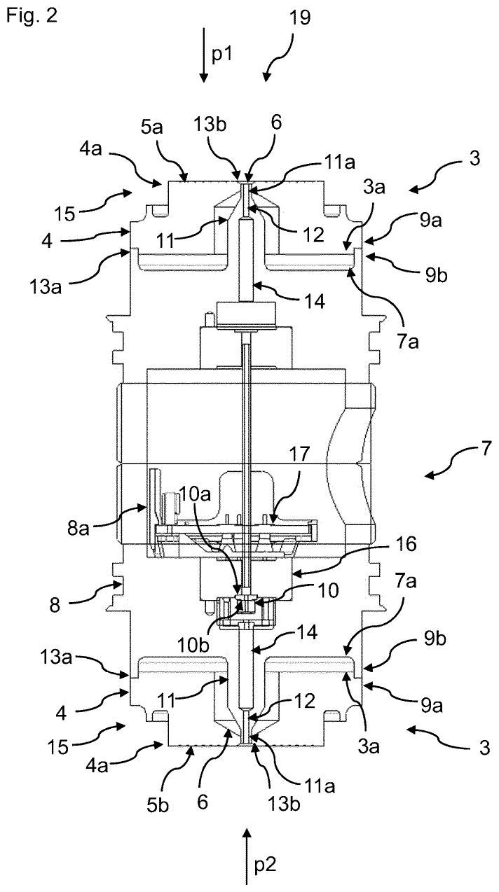

The present invention is explained in more detail below with reference to the following FIGS. 1-2. Shown are:

FIG. 1: an embodiment of the pressure transducer according to the invention.

FIG. 2: an embodiment of the differential pressure transducer according to the invention.

Where possible, the same reference symbols are used for identical or corresponding parts of the pressure transducer 1 and the differential pressure transducer 19.

FIG. 1 shows an embodiment of a pressure transducer 1 according to the invention for determining a first pressure p1 of a medium 2. The pressure transducer 1 comprises a process module 3 with a cylindrical main part 4 made of a first material and a measuring module 7 with a cylindrical base 8 made of a second material. The first material differs from the second material. In particular, the first material is a corrosion-resistant material. For example, the second material is less resistant to corrosion than the first material. The first material may be a nickel alloy or, for example, Hastelloy, Inconel or Monel. The second material is steel, for example.

The base 8 has a pressure sensor 10 with a first surface 10a and a second surface 10b opposite the first surface 10a, as well as a pin-like portion 11. The process module 3 is disposed on the process side and has a pressure-sensitive process diaphragm 5 in the end portion 4a of the main part 4 facing the medium 2, which is subjected to the first pressure p1 of the medium 2. The main part 4 also has an axially disposed through-hole 6 which tapers towards the end portion 4a of the main part 4 facing the medium 2. Optionally, the main part 4 has an attachment region 15 for a connection to a process connection (not shown). The second pressure p2 can be an absolute pressure or a reference pressure; in the example shown in FIG. 1, the second pressure p2 is a reference pressure which is supplied to the second surface 10b of the pressure sensor 10 by means of a reference air bore 18 in the base 8 designed for this purpose.

The process module 3 and the measuring module 7 are axially aligned with each other. The pin-like portion 11 protrudes into the through-hole 6 so that the end portion 11a of the pin-like portion 11 is flush with the end portion 4a of the main part 4 facing the medium 2. The pin-like portion 11 tapers in the direction of the end portion 11a of the pin-like portion. The process module 3 and the measuring module 7 are connected to each other at at least two points. On the one hand, an end face 3a of the process module 3 is connected to an end face 7a of the measuring module 7 in a respective connection region 9a, 9b. The connection region 9a of the process module 3 and the connection region 9b of the measuring module 7 are ring-shaped, for example, and welded together by means of a first weld 13a. On the other hand, the end portion 11a of the pin-like portion 11 is connected to the end portion 4a of the main part 4 facing the medium 2, for example by means of a second weld 13b. In a preferred embodiment, the process module 3 and the measuring module 7 only touch in their respective connection regions 9a, 9b and between the end portion 11a of the pin-like portion 11 and the end portion 4a of the main part 4 facing the medium 2. In the example shown in FIG. 1, the connection region 9a of the process module 3 corresponds to the connection region 9b of the measuring module 7. For example, the connection region 9a of the process module 3 and/or the connection region 9b of the measuring module 7 is an edge, a shoulder, a protrusion or a step.

The pin-like portion 11 has a capillary 12 which is designed to transfer the first pressure p1 of the medium 2 from the process diaphragm 5 to the first surface 10a of the pressure sensor 10. An optional pin 14 may be disposed inside the capillary 12, which is designed in such a way that the pin 14 acts together with the capillary 12 as a flashback arrestor. An electrically insulating feed-through element 16 can also be provided which separates the pressure sensor 10 from at least one electronic unit 17. Both the pressure sensor 10 and the feed-through element 16 and the at least one electronic unit 17 are installed in a recess 8a of the base 8 in the example in FIG. 1. The feed-through element 16 is preferably made of the same material as the base in order to avoid temperature-dependent stresses and/or distortion forces when connecting the feed-through element 16 to the base 8. In addition, an alignment element 20, e.g., in the form of a pin, may be disposed, which ensures a predetermined alignment of the feed-through element 16 relative to the base 8.

FIG. 2 shows an embodiment of the differential pressure transducer 19 according to the invention for determining a differential pressure from a first pressure p1 and a second pressure p2. Since both the first pressure p1 and the second pressure p2 originate from a medium 2, the differential pressure transducer has two process modules 3, each with a cylindrical main part 4 made of a first material. A pressure-sensitive process diaphragm 5a, 5b is disposed in one end portion 4a of each of the two main parts 4 facing the medium 2. The first process diaphragm 5a is subjected to the first pressure p1, and the second process diaphragm 5b is subjected to the second pressure p2. The two main parts 4 each have an axially disposed through-hole 6 which tapers towards the end portion 4a of the main part 4 facing the medium 2.

The differential pressure transducer 19 also has a measuring module 7 with a cylindrical base 8, which is disposed between the two process modules 3 in FIG. 2. The two process modules 3 are aligned in a common axis, but they could also be disposed coplanar so that the arrangement of the measuring module 7 would have to be changed accordingly. The base 8 is made of a second material different from the first material and has two pin-like portions 11 and a pressure sensor 10 with a first surface 10a and a second surface 10b opposite the first surface 10a. The two pin-like portions 11 taper in the direction of their respective end portions 11a.

Both process modules 3 are aligned axially to the measuring module 7, with the two pin-like portions 11 of the base 8 each projecting into the through-hole 6 of the respective main part 4 in such a way that one end portion 11a of the pin-like portion 11 each is flush with the respective end portion 4a of the main part 4 facing the medium 2. The respective end portion 11a of the pin-like portion 11 is connected to the respective end portion 4a of the main part 4 facing the medium 2. In addition, a respective end face 3a of the two process modules 3 is connected to a respective end face 7a of the measuring module in a respective connection region 9a, 9b.

The two pin-like portions 11 have a first capillary 12a and a second capillary 12b. The first capillary 12a is designed to transmit the first pressure p1 from the first process diaphragm 5a to a first surface 10a of the pressure sensor 10. The second capillary 12b is designed to transmit the second pressure p2 from the second process diaphragm 5b to a second surface 10b of the pressure sensor 10 opposite the first surface 10a.

### LIST OF REFERENCE SIGNS

1 Pressure transducer
2 Medium
3 Process module
3a End face of the process module
4 Main part
4a End portion of the main part
5 Process diaphragm
5a First process diaphragm
5b Second process diaphragm
6 Through-hole
7 Measuring module
7a End face of the measuring module
8 Base
8a Recess in the base
9a Connection region of the process module
9b Connection region of the measuring module
10 Pressure sensor
10a First surface
10b Second surface
11 Pin-like portion
11a End portion of the pin-like portion
12 Capillary
13a First weld
13b Second weld
14 Pin
15 Attachment region
16 Feed-through element
17 Electronic unit
18 Reference air bore
19 Differential pressure transducer
20 Alignment element

1-15. (canceled)

16. A pressure transducer for determining a first pressure of a medium, comprising:
a process module with a cylindrical main part made of a first material,
wherein a pressure-sensitive process diaphragm is provided in an end portion of the main part facing the medium,
the main part having an axially disposed through-hole which tapers towards the end portion of the main part facing the medium,
a measuring module with a cylindrical base, the process module and the measuring module being axially aligned with respect to one another and connected to one another in a respective connecting region of a respective end face of the process module and of the measuring module, the base being made of a second material which differs from the first material, the base having a pressure sensor and a pin-like portion,
wherein the pin-like portion projects into the through-hole in such a way that an end portion of the pin-like portion is flush with the end portion of the main part facing the medium, wherein the end portion of the pin-like portion is connected to the end portion of the main part facing the medium, wherein the pin-like portion tapers in the direction of the end portion of the pin-like portion, wherein the pin-like portion has a capillary which is designed to transmit the first pressure of the medium from the process diaphragm to a first surface of the pressure sensor,
wherein the pressure sensor is subjected to a second pressure on a second surface opposite the first surface.

17. The pressure transducer according to claim 16,
wherein the first material is a corrosion-resistant material.

18. The pressure transducer according to claim 16,
wherein the second material is less corrosion-resistant than the first material.

19. The pressure transducer according to claim 16,
wherein the first material is a nickel alloy.

20. The pressure transducer according to claim 16
wherein the first material is Hastelloy, Inconel or Monel.

21. The pressure transducer according to claim 16,
wherein the second material is a steel.

22. The pressure transducer according to claim 16,
wherein the respective connecting region of the end face of the process module and the end face of the measuring module is ring-shaped.

23. The pressure transducer according to claim 16,
wherein the connecting region of the process module and/or the connecting region of the measuring module is designed as a step, shoulder, projection or edge, the connecting region of the process module and the connecting region of the measuring module being designed to correspond to one another.

24. The pressure transducer according to claim 16,
wherein the process module and the measuring module are in contact exclusively in the respective connecting region and between the end portion of the pin-like portion and the end portion of the main part facing the medium.

25. The pressure transducer according to claim 16,
wherein the process module and the measuring module are connected in the respective connecting region of the respective end face by means of a first weld, the end portion of the pin-like portion being connected to the end portion of the main part facing the medium by means of a second weld.

26. The pressure transducer according to claim 16,
wherein a pin is disposed inside the capillary, which is designed in such a way that the pin acts together with the capillary as a flashback arrestor.

27. The pressure transducer according to claim 16,
wherein the main part of the process module has an attachment region for a connection to a process connection.

28. The pressure transducer according to claim 16,
wherein the pressure sensor is separated from at least one electronic unit by means of an electrically insulating feed-through element, which is inserted into a recess in the base.

29. The pressure transducer according to claim 16,
wherein the second pressure is an absolute pressure or a reference pressure, wherein in the case of the reference pressure, the base has a reference air bore which is designed to guide the reference pressure through the base to the second surface of the pressure sensor.

30. A differential pressure transducer for determining a differential pressure from a first pressure and a second pressure, comprising:
two process modules, each with a cylindrical main part made of a first material,
a pressure-sensitive process diaphragm being provided in each end portion of the main part facing the medium, wherein the first process diaphragm is subjected to the first pressure, and the second process diaphragm is subjected to the second pressure,
the main part having an axially disposed through-hole which tapers towards the end portion of the main part facing the medium,
a measuring module with a cylindrical base, the two process modules each being aligned axially to the measuring module and connected to one another in a respective connecting region of a respective end face of the respective process module and a respective end face of the measuring module, the base being made of a second material which differs from the first material, the base having a pressure sensor and two pin-like portions,
wherein the two pin-like portions each project into the through-hole of the respective main part in such a way that one end portion of the pin-like portion is flush with the respective end portion of the main part facing the medium, the respective end portion of the pin-like portion being connected to the respective end portion of the main part facing the medium, the two pin-like portions tapering in the direction of their respective end portion, the two pin-like portions having a first capillary and a second capillary, the first capillary being designed to transmit the first pressure from the first process diaphragm to a first surface of the pressure sensor, and the second capillary being designed to transmit the second pressure from the second process diaphragm to a second surface of the pressure sensor opposite the first surface.
